(19) United States
(12) Patent Application Publication
(10) Pub. No.: US 2016/0368444 A1
(43) Pub. Date: Dec. 22, 2016

(54) VEHICLE CONTROL SYSTEM FOR PASSENGER PROTECTION AND METHOD THEREOF

(71) Applicant: KYUNG CHANG INDUSTRIAL CO., Ltd., Daegu (KR)

(72) Inventors: Jung Hyun Kim, Gyeongsangbuk-do (KR); Tae Hun Park, Daegu (KR); Sung-Il Byun, Daegu (KR); Jung-Hun Lee, Daegu (KR)

(21) Appl. No.: 14/818,467

(22) Filed: Aug. 5, 2015

(30) Foreign Application Priority Data
Jun. 17, 2015 (KR) 1020150085850

(51) Int. Cl. B60R 21/01; H04N 5/225; B60R 16/023; B60Q 9/00; E05F 15/73

(52) U.S. Cl. CPC B60R 21/01; B60Q 9/00; E05F 15/73; B60R 16/023; H04N 5/225

(57) ABSTRACT

A vehicle control unit may be provided that protects passengers of a vehicle while entering and exiting the vehicle. When the door opening closing operation signal or the speed meets a predetermined condition, the vehicle control unit receives information on whether a threat exists in the side or rear of the vehicle. When the threat does not exist, the vehicle control unit outputs the door opening closing operation signal to the door control unit and outputs the acceleration pedal rotation angle to the engine control unit. When the threat exists, the vehicle control unit does not output the door opening closing operation signal to the door control unit or does not output the door opening closing operation signal controlled to prevent the door from being opened to the door control unit and outputs an on-signal to the warning light or the buzzer disposed within the vehicle.

### CROSS REFERENCE TO RELATED APPLICATIONS

Priority is claimed under 35 U.S.C. §119 to Korean Patent Application No.: 10-2015-0085850, filed Jun. 17, 2015, the disclosure of which is incorporated herein by reference in its entirety.

### FIELD OF THE INVENTION

The present invention relates to a vehicle control system for protecting passengers of a vehicle, and more particularly to a vehicle control system which detects threats around the vehicle and protects passengers getting in and out of the vehicle.

### BACKGROUND OF THE INVENTION

With an automated opening/closing system installed in the entrance/exit door of a vehicle, a small sized van for commuting to school as well as a large sized van currently being operated like a bus can be driven by one driver without a guider which guides passengers to get out of the vehicle. However, under this condition, there is always a probability that an accident occurs when passengers get in and out of the vehicle. Also, the vehicle is being driven with a lack of a safety management for passengers getting in and out of the vehicle.

Sometimes, there often is delivered a sad news that an accident occurs where after children or students get out of a kindergarten bus or an academy bus, the driver of the vehicle starts to move the vehicle without recognizing their belongings caught in the vehicle door, or that a crash accident occurs where after the driver or fellow passenger stays the vehicle at a place where he/she is not able to recognize the children or students, the vehicle starts and crashes them. In most cases, the accidents are caused by a blind spot where the driver or fellow passenger is not able to recognize due to the nature of the vehicle, or sometimes by carelessness. Particularly, in case of a vehicle intended for children, for example, a commuting vehicle (school bus, academy bus, kindergarten vehicle, etc.), many accidents have occurred to children who are lack of correct judgment and action in getting in and out of the vehicle. That is, a child has a small sized body and insufficient attention, judgment and exercise ability and it is frequent that a child falls down at a position adjacent to the vehicle or makes mischief at the time of getting in and out of the vehicle, so that there is a high probability that accidents occur. Due to a careless driver who ignores the high accident probability, Due to a careless driver who ignores the high accident probability, accidents increase when infants or children get in and out of the vehicle.

Also, when a passenger's belongings, for example, a bag, etc., or clothes are caught in the vehicle door at the time of getting in and out of the vehicle, the driver may close the door without recognizing their belongings caught in the vehicle door, so that the secondary accident may occur. In other words, although the driver is required to start to move the vehicle after the passengers completely get out of the vehicle, the accident caused by the fact that the vehicle moves again without obtaining visibility owing to the blind spot of the vehicle or other reasons occurs frequently.

Also, in general, regarding a vehicle such as a car or a van, when the driver or passenger gets out of the vehicle in a stop state of the vehicle, the driver or passenger is inevitably exposed to a dangerous object like other vehicles, a motor cycle, a handcart, etc., which move on the external adjacent road or sidewalk, so that the consequent accidents often occurs. Here, the driver or passenger needs to make sure whether a vehicle, bicycle, motorcycle or the like is approaching or not when getting out of the vehicle. The driver should pay attention to not only the vehicle driving but also the safety of the passengers getting in and out of the vehicle. Therefore, the driver's fatigue increases and safe driving may be inhibited.

In the past, so as to prevent the above accidents, dangerous situations have been monitored by installing a rear-monitoring blind spot minor (a convex lens), etc., on the upper and lower portions of the side-view minor. The blind spot minor allowing the driver to monitor the side and rear of the vehicle depends on the visual sense of the driver positioning on a driver's seat. When the driver is a little careless, large scale accidents may be caused. Since the blind spot minor has a very limited monitoring range, the above problems cannot be solved. Also, the driver gets out of the vehicle and guides children for himself/herself, or an auxiliary companion gets out of the vehicle and guides children. In this method, when the driver and auxiliary companion get in the vehicle after causing the children to get in and out of the vehicle, the children may approach again the side to rear of the vehicle. In this case, the driver and auxiliary companion are not able to monitor the children, so that unexpected accidents may occur. Also, the driver and auxiliary companion who have a short driving time concentrate their attention only to children's getting in and out of the vehicle, so that the positions of the children who have got in and out of the vehicle cannot be often recognized. Accordingly, the above-mentioned problems may occur. Also, there is a system in which a sensor mainly installed on the vehicle door detects an object caught in a vehicle door and warns it or opens the door again. However, when the passengers having no object caught in the door approach the side of the vehicle, the passengers cannot be detected.

### SUMMARY OF THE INVENTION

One embodiment is a vehicle control unit that protects passengers of a vehicle including a door switch, a speed sensor, an acceleration pedal rotation angle sensor, a door control unit, an engine control unit, and at least one of a warning light and a buzzer. The vehicle control unit receives a door opening closing operation signal from the door switch, receives a speed of the vehicle from the speed sensor, and receives an acceleration pedal rotation angle from the acceleration pedal rotation angle sensor. When the door opening closing operation signal or the speed meets a predetermined condition, the vehicle control unit receives information on whether a threat exists or not in the side or rear of the vehicle. When the threat does not exist in the side or rear of the vehicle, the vehicle control unit outputs the door opening closing operation signal to the door control unit and outputs the acceleration pedal rotation angle to the engine control unit. When the threat exists in the side or rear of the vehicle, the vehicle control unit does not output the door opening closing operation signal to the door control unit or does not output the door opening closing operation signal controlled to prevent the door from being opened to the door control unit and outputs an on-signal to the warning light or the buzzer disposed within the vehicle.

Also, another embodiment is a vehicle control system which protects passengers of a vehicle including a door switch, a speed sensor, an acceleration pedal rotation angle sensor, a door control unit, an engine control unit, and at least one of a warning light and a buzzer. The vehicle control system includes: a video analysis unit; and a vehicle control unit. The vehicle control unit receives a door opening closing operation signal from the door switch, receives a speed of the vehicle from the speed sensor, receives an acceleration pedal rotation angle from the acceleration pedal rotation angle sensor, and receives information on whether or not a threat exists in the side or rear of the vehicle from the video analysis unit. When the threat does not exist in the side or rear of the vehicle, the vehicle control unit outputs the door opening closing operation signal to the door control unit and outputs an acceleration pedal rotation angle to the engine control unit. When the threat exists in the side or rear of the vehicle, the vehicle control unit does not output the door opening closing operation signal to the door control unit or outputs the door opening closing operation signal controlled to prevent the door from being opened to the door control unit, and outputs an on-signal to the warning light or the buzzer disposed within the vehicle. The video analysis unit receives a first video signal from a first video sensor which records the side of the vehicle or a second video signal from a second video sensor which records the rear of the vehicle. When the door opening closing operation signal or the speed meets a predetermined condition, the video analysis unit determines whether or not the threat exists in the side or rear of the vehicle on the basis of the first video signal or the second video signal, and outputs the information on whether or not the threat exists in the side or rear of the vehicle to the vehicle control unit.

Further another embodiment is a vehicle including a vehicle control system for protecting passengers. The vehicle includes: the vehicle control system including a video analysis unit a vehicle control unit; a first video sensor which records the side of the vehicle and outputs a recorded first video signal to the vehicle control system; a second video sensor which records the rear of the vehicle and outputs a recorded second video signal to the vehicle control system; a door switch which is disposed within the vehicle and outputs a door opening closing operation signal to the vehicle control system; an acceleration pedal rotation angle sensor which outputs an acceleration pedal rotation angle of the vehicle to the vehicle control system; a speed sensor which outputs a speed of the vehicle to the vehicle control system; a door control unit which drives a door of the vehicle; an engine control unit which drives an engine of the vehicle; and at least one of a warning light and a buzzer which is disposed within the vehicle. The vehicle control unit receives information on whether or not a threat exists in the side or rear of the vehicle from the video analysis unit. When the threat does not exist in the side or rear of the vehicle, the vehicle control unit outputs the door opening closing operation signal to the door control unit and outputs the acceleration pedal rotation angle to the engine control unit. When the threat exists in the side or rear of the vehicle, the vehicle control unit does not output the door opening closing operation signal to the door control unit or outputs the door opening closing operation signal controlled to prevent the door from being opened to the door control unit, and outputs an on-signal to the warning light or the buzzer. When the door opening closing operation signal or the speed meets a predetermined condition, the video analysis unit determines whether or not the threat exists in the side or rear of the vehicle on the basis of the first video signal or the second video signal, and outputs the information on whether or not the threat exists in the side or rear of the vehicle to the vehicle control unit.

Yet another embodiment is a vehicle control method for protecting passengers of a vehicle. The method includes: starting to detect a threat when a threat detection condition is met; determining whether or not the threat exists in the side or rear of the vehicle when a door switch of the vehicle is turned on to allow the passengers to get out of the vehicle; preventing the door of the vehicle from being opened, operating a warning light or a buzzer, and displaying a warning signal on a monitor when the threat exists in the side or rear of the vehicle; determining whether or not the threat exists in the side of the vehicle when the door switch is turned off in order to start to move the vehicle; preventing the door of the vehicle from being closed, operating the warning light or the buzzer, displaying the warning signal on the monitor, and preventing the vehicle from being accelerated, when the threat exists in the side of the vehicle; and stopping detecting the threat when the threat detection condition is not met.

Still another embodiment is a vehicle control method for protecting passengers of a vehicle. The method includes: starting to detect a threat when a door switch of the vehicle is turned on to allow the passengers to get out of the vehicle; determining whether or not the threat exists in the side or rear of the vehicle; preventing the door of the vehicle from being opened, operating a warning light or a buzzer, and displaying a warning signal on a monitor when the threat exists in the side or rear of the vehicle; determining whether or not the threat exists in the side of the vehicle when the door switch is turned off in order to start to move the vehicle; preventing the door of the vehicle from being closed, operating the warning light or the buzzer, displaying the warning signal on the monitor, and preventing the vehicle from being accelerated, when the threat exists in the side of the vehicle; and stopping detecting the threat when the threat does not exist in the side of the vehicle.

### BRIEF DESCRIPTION OF DRAWINGS

FIG. 1 is a block diagram showing a configuration of a vehicle equipped with a vehicle control system in accordance with an embodiment of the present invention;

FIG. 2 is a view showing an inside of the vehicle equipped with the vehicle control system in accordance with the embodiment of the present invention;

FIG. 3 is a view showing an outside of the vehicle equipped with the vehicle control system in accordance with the embodiment of the present invention;

FIG. 4 is a view showing an operation of the vehicle equipped with the vehicle control system in accordance with the embodiment of the present invention;

FIG. 5 is a flowchart for describing a vehicle control method of the vehicle control system according to the embodiment of the present invention;

FIG. 6 is a graph showing time-based operations of the vehicle control method shown in FIG. 5;

FIG. 7 is a flowchart for describing a vehicle control method of a vehicle control system according to another embodiment of the present invention;

FIG. 8 is a graph showing time-based operations of the vehicle control method shown in FIG. 7;

FIG. 9 is a flowchart for describing the vehicle control method of the vehicle control system which further includes a control function depending on a shift lever state in accordance with the embodiment of the present invention;

FIG. 10 is a flowchart for describing the vehicle control method of the vehicle control system which further includes a control function depending on a video sensor operation state in accordance with the embodiment of the present invention;

FIG. 11 is a flowchart for describing the vehicle control method of the vehicle control system which further includes a control function depending on a communication state in accordance with the embodiment of the present invention; and

FIG. 12 is a flowchart for describing the vehicle control method of the vehicle control system which further includes a release function in accordance with the embodiment of the present invention.

### DETAILED DESCRIPTION OF THE INVENTION

The objects, particular advantages and novel features of the present invention will be more apparent from the following descriptions and exemplary embodiments which are related to the accompanying drawings. In the drawings, the same or similar elements are denoted by the same reference numerals even though they are depicted in different drawings. While terms such as the first and the second, etc., can be used to describe various components, the components are not limited by the terms mentioned above. The terms are used only for distinguishing between one component and other components. Throughout the description of the present invention, the detailed description of known technologies incorporated herein will be omitted when it may make the subject matter of the present invention unclear.

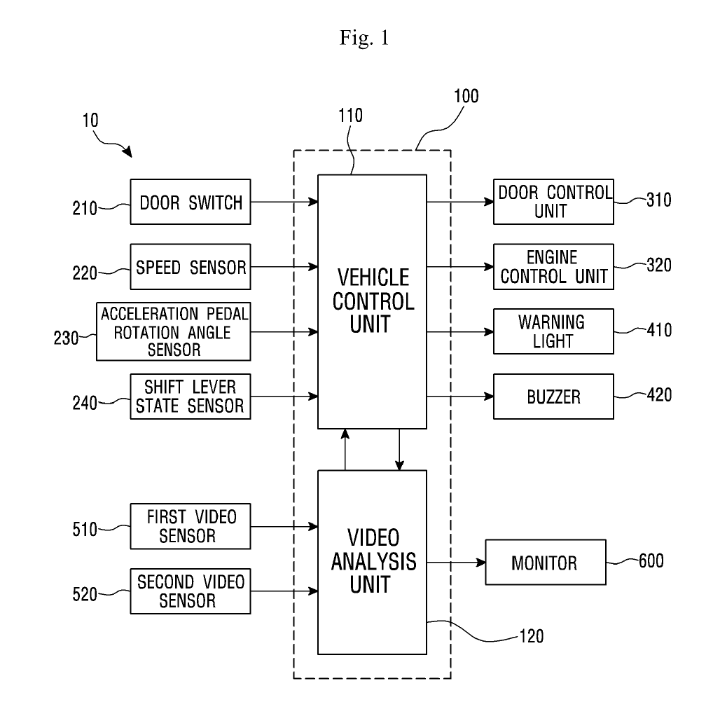

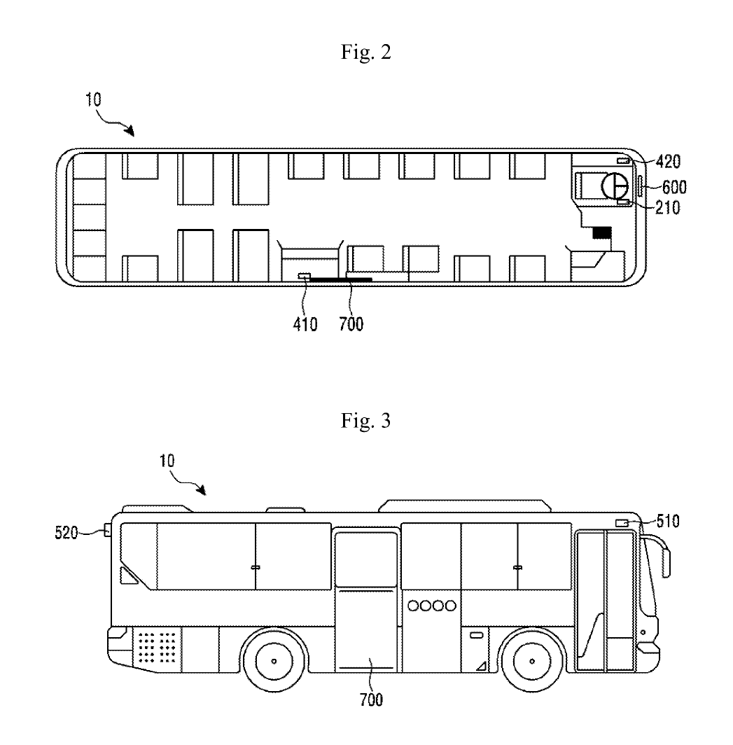

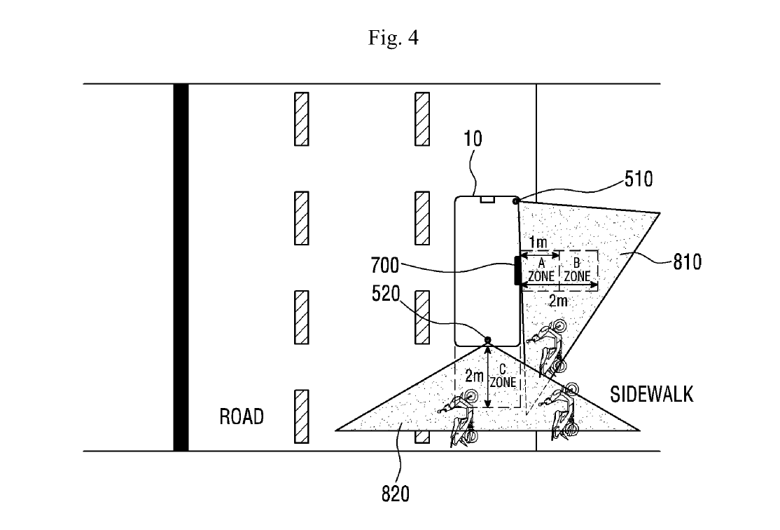

An embodiment of the present invention will be described in detail with reference to the accompanying drawings. FIG. 1 is a block diagram showing a configuration of a vehicle equipped with a vehicle control system in accordance with an embodiment of the present invention. FIG. 2 is a view showing an inside of the vehicle equipped with the vehicle control system in accordance with the embodiment of the present invention. FIG. 3 is a view showing an outside of the vehicle equipped with the vehicle control system in accordance with the embodiment of the present invention. FIG. 4 is a view showing an operation of the vehicle equipped with the vehicle control system in accordance with the embodiment of the present invention.

As shown in FIG. 1, a vehicle 10 according to the embodiment of the present invention may include a vehicle control system 100, a door switch 210, a speed sensor 220, an acceleration pedal rotation angle sensor 230, a door control unit 310, an engine control unit 320, a warning light 410, a buzzer 420, a first video sensor 510, and a second video sensor 520.

As shown in FIGS. 3 and 4, the first video sensor 510 according to the embodiment of the present invention may record the side of the vehicle 10. Specifically, the first video sensor 510 may be a camera which uses a fisheye lens. The first video sensor 510 is disposed on the front right side of the vehicle 10 and can record a first area 810 of the right side of the vehicle 10. The first video sensor 510 may output a first video signal for the recorded first area 810 to the vehicle control system 100. Also, the second video sensor 520 according to the embodiment of the present invention may record the rear of the vehicle 10. Specifically, the second video sensor 520 may be a camera which uses a general lens. The second video sensor 520 is disposed on the rear of the vehicle 10 and can record a second area 820 of the rear of the vehicle 10. The second video sensor 520 may output a second video signal for the recorded second area 820 to the vehicle control system 100. Here, the first video signal or the second video signal in an analog format may be converted into the first video signal or the second video signal in a digital format by a decoder included in the vehicle control system 100.

The door switch 210 according to the embodiment of the present invention opens or closes a door 700 of the vehicle 10. Specifically, as shown in FIG. 2, the door switch 210 may be disposed adjacent to a driver's seat within the vehicle 10 such that the driver can operate it. When the driver operates the door switch 210, the door switch 210 may output a door opening closing operation signal to the vehicle control system 100.

The acceleration pedal rotation angle sensor 230 according to the embodiment of the present invention senses an acceleration pedal rotation angle of the vehicle 10. Specifically, when the driver steps on the acceleration pedal, the acceleration pedal is pivoted about a rotational axis. The acceleration pedal rotation angle sensor 230 is disposed on an acceleration pedal module and senses the acceleration pedal rotation angle which is changed by the stepping force of the driver. The acceleration pedal rotation angle sensor 230 may output the sensed acceleration pedal rotation angle to the vehicle control system 100.

The speed sensor 220 according to the embodiment of the present invention senses the speed of the vehicle 10. Specifically, the speed sensor 220 may be a vehicle diagnostic system (On-Board Diagnosis II, OBD II). The speed sensor 220 may output the sensed speed of the vehicle 10 to the vehicle control system 100 by using a controlled area network (CAN) communication.

The vehicle control system 100 according to the embodiment of the present invention may include a vehicle control unit 110 and a video analysis unit 120.

The vehicle control unit 110 may output the door opening closing operation signal received from the door switch 210 and the speed received from the speed sensor 220 to the video analysis unit 120. Specifically, the vehicle control unit 110 extracts speed information from among various pieces of vehicle state information inputted from the vehicle diagnostic system through the CAN communication, and then may output the speed information to the video analysis unit 120.

The video analysis unit 120 determines whether or not the door opening closing operation signal or the speed which has been inputted from the vehicle control unit 110 meets a predetermined condition. Here, the predetermined condition may be that the door opening closing operation signal is in an on-state or the speed is less than a predetermined speed. Here, the predetermined speed may be 20 km/h. When the door opening closing operation signal or the speed meets the predetermined condition, the video analysis unit 120 may determine whether or not the threat exists in the side or rear of the vehicle 10 on the basis of the first video signal which has been converted into a digital format or the second video signal which has been converted into a digital format. Then, the video analysis unit 120 may output the information on whether or not the threat exists in the side or rear of the vehicle 10 to the vehicle control unit 110. Here, the video analysis unit 120 may output the information on whether or not the threat exists in the side or rear of the vehicle 10 to the vehicle control unit 110 by using a universal asynchronous receiver transmitter (UART) communication. Specifically, as shown in FIG. 4, the video analysis unit 120 may determine whether or not the threat exists in the first area 810 of the side of the vehicle 10 or in the second area 820 of the rear of the vehicle 10 on the basis of the first video signal recorded by the first video sensor 510 and/or the second video signal recorded by the second video sensor 520.

The vehicle control unit 110 receives the information on whether or not the threat exists in the side or rear of the vehicle 10 from the video analysis unit 120. When the threat does not exist in the side or rear of the vehicle 10, the vehicle control unit 110 may output the door opening closing operation signal to the door control unit 310 and may output the acceleration pedal rotation angle to the engine control unit 320. Also, when the threat exists in the side or rear of the vehicle 10, the vehicle control unit 110 may not output the door opening closing operation signal to the door control unit 310 or may output the door opening closing operation signal controlled to prevent the door from being opened to the door control unit 310 and may output an on-signal to the warning light 410 or the buzzer 420. Here, when the threat exists in the side of the vehicle 10 in a state where the door 700 of the vehicle 10 is opened, the vehicle control unit 110 may not output the door opening closing operation signal to the door control unit 310 or may output the door opening closing operation signal controlled to prevent the door from being closed to the door control unit 310, may output an on-signal to the warning light 410 or the buzzer 420, and may output the controlled acceleration pedal rotation angle to the engine control unit 320. Here, the controlled acceleration pedal rotation angle may be intended not to accelerate the vehicle and may be 0 degree.

The door control unit 310 according to the embodiment of the present invention may drive the door 700 of the vehicle 10 in accordance with the door opening closing operation signal inputted from the vehicle control unit 110. Specifically, when the door opening closing operation signal inputted from the vehicle control unit 110 is in the on-state, the door control unit 310 may drive and open the door 700 of the vehicle 10, and when the door opening closing operation signal inputted from the vehicle control unit 110 is in an off-state, the door control unit 310 may drive and open the door 700 of the vehicle 10.

The engine control unit 320 according to the embodiment of the present invention may drive the engine of the vehicle 10 in accordance with the acceleration pedal rotation angle inputted from the vehicle control unit 110 or the controlled acceleration pedal rotation angle. Specifically, the engine control unit 320 drives the engine by controlling how much a throttle valve is opened in accordance with the acceleration pedal rotation angle inputted from the vehicle control unit 110 or the controlled acceleration pedal rotation angle, and may control the speed of the vehicle 10.

The warning light 410 and buzzer 420 according to the embodiment of the present invention are means for notifying the driver or passengers of the vehicle 10 that the threat exists outside the vehicle 10. Specifically, as shown in FIG. 2, the warning light 410 and buzzer 420 may be disposed adjacent to the door 700 within the vehicle 10 and notify the passengers getting out of the vehicle that the threat exists outside the vehicle 10, or may be disposed adjacent to the driver's seat within the vehicle 10 and notify the driver that the threat exists outside the vehicle 10. When an on-signal is inputted to the warning light 410 and buzzer 420 from the vehicle control unit 110, the warning light 410 provides a visual warning to the passengers or driver by emitting light or blinking, or the buzzer 420 provides an acoustic warning to the passengers or driver by ringing.

As shown in FIG. 2, the vehicle 10 according to the embodiment of the present invention may further include a monitor 600.

The video analysis unit 120 may output the first video signal or the second video signal to the monitor 600. Here, if a threat exists in the side or rear of the vehicle 10, the video analysis unit 120 may output the first video signal and/or the second video signal which include a warning signal to the monitor 600. Here, the first video signal in a digital format or the second video signal in a digital format may be output to the monitor 600, or the first video signal in a digital format or the second video signal in a digital format may be converted into the first video signal in an analog format or the second video signal in an analog format by an encoder included in the vehicle control system 100 and may be output to the monitor 600.

The monitor 600 according to the embodiment of the present invention may display the first video signal or the second video signal which has been converted into a digital format or into an analog format. Here, when the first video signal or the second video signal including the warning signal is inputted to the monitor, the color of at least a portion of the edge area of the monitor screen is changed into a color attracting attention or at least a portion of the edge area of the monitor screen blinks.

The vehicle 10 according to the embodiment of the present invention may further include a shift lever state sensor 240.

The shift lever state sensor 240 according to the embodiment of the present invention may sense a shift lever state of the vehicle 10. Specifically, the operation of the shift lever by the driver changes the position of the shift lever. The shift lever state sensor 240 is disposed on a shift lever module of the vehicle 10 and is able to sense a shift lever state which is changed by the operation of the shift lever by the driver. The shift lever state sensor 240 may output information on the sensed shift lever state to the vehicle control system 100. Here, the shift lever state information can be detected by the vehicle diagnostic system. Likewise, the information on the sensed shift lever state can be outputted to the vehicle control system 100 through use of the CAN communication.

The vehicle control unit 110 may output the shift lever state information to the video analysis unit 120. The video analysis unit 120 determines whether the input shift lever state is a reverse position or not. When the shift lever state is the reverse position, the video analysis unit 120 may output the second video signal to the monitor 600. Here, the monitor 600 may display only the second video signal on its entire screen. When the input shift lever state is not the reverse position, the video analysis unit 120 may output the first video signal and the second video signal to the monitor 600. Here, the monitor 600 may divide its screen and display both of the first video signal and the second video signal.

The vehicle control unit 110 and the video analysis unit 120 may be constituted by a central processing unit (CPU) performing its operations and a printed circuit board (PCB) including the CPU, respectively. Also, the respective CPUs may comprise one PCB, or the vehicle control unit 110 and the video analysis unit 120 may be constituted by one CPU.

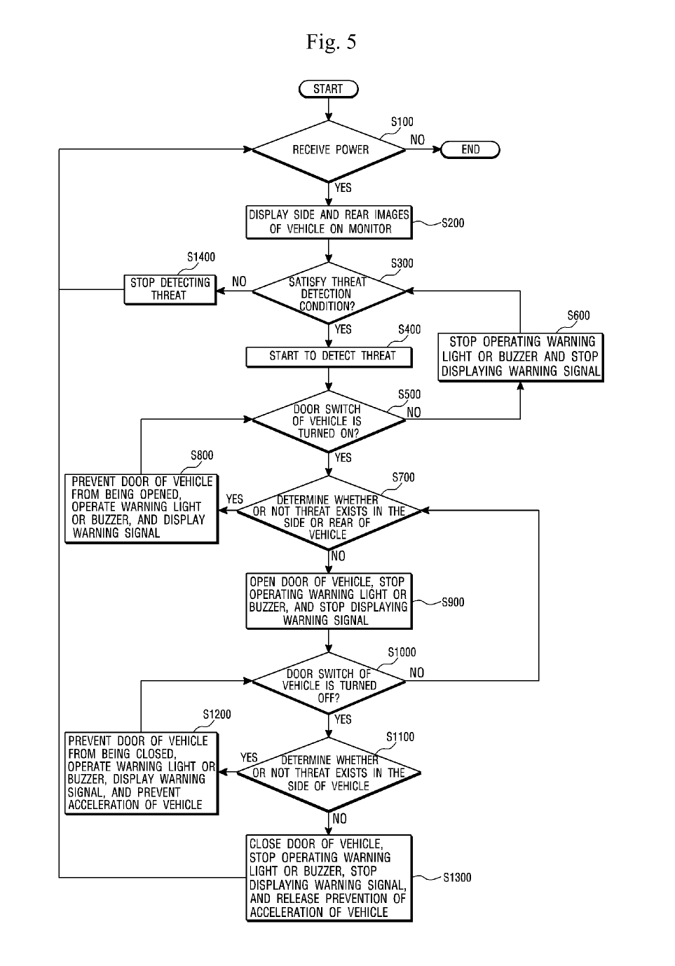

FIG. 5 is a flowchart for describing a vehicle control method of the vehicle control system according to the embodiment of the present invention.

When a switch supplying power to a starting power is turned on, the vehicle control system 100 receives the power and starts to operate (S100).

The side and rear images of the vehicle 10 are displayed on the monitor (S200). Specifically, the monitor 600 displays the side image of the vehicle 10, which has been recorded by the first video sensor 510 and the rear image of the vehicle 10, which has been recorded by the second video sensor 520. Here, the display area of the monitor is divided into two areas, and thus, the side image of the vehicle 10 and the rear image of the vehicle 10 can be simultaneously displayed.

It is determined whether a threat detection condition is satisfied or not (S300). The threat detection condition is used to detect the threat around the vehicle 10 at about the time when the passengers get out of the vehicle 10. That is, when it is not at about the time when the passengers get out of the vehicle 10, the side and rear images of the vehicle 10 are displayed on the monitor 600, however, and the threat is not detected. In other words, in general, the threat around the vehicle 10 is not detected when the vehicle 10 travels, and the threat around the vehicle 10 is detected at about the time when the passengers get out of the vehicle 10 at a bus stop, etc.

The threat detection condition may be that the speed of the vehicle 10 is less than a predetermined speed. When the speed of the vehicle 10 is greater than a predetermined speed, the vehicle 10 is generally traveling and the passengers are not expected to get out of the vehicle 10. When the speed of the vehicle 10 is less than a predetermined speed, the vehicle 10 decreases its speed or stops to allows the passengers to get out of the vehicle 10 or the vehicle 10 starts to move after the passengers get out of the vehicle 10. Here, the predetermined speed may be 20 km/h. When the threat detection condition is set that the speed of the vehicle 10 is less than a predetermined speed, the threat may be detected from a time point before a point of time when the door of the vehicle 10 which has completely stopped is opened and the passengers get out of the vehicle to a time point after a point of time when the passengers have completed getting out of the vehicle and the door 700 of the vehicle 10 is closed. There is no necessity of a separate device related to the detection of the passengers' getting out of the vehicle. Also, by using the position and speed of the threat detected from a time point before a point of time when the passengers get out of the vehicle, it is possible to more reliably determine whether a below-described threat exists in a predetermined area or not.

Also, the threat detection condition may be that the vehicle 10 is located within a predetermined distance from a predetermined vehicle stop location, e.g., a bus stop, etc. During a period of time from when the vehicle 10 enters within a predetermined distance from a predetermined vehicle stop location to when the vehicle 10 gets out of the predetermined distance, the passengers may be expected to get out of the vehicle. In this case, the vehicle control system 100 receives the position of the vehicle 10 from a global positioning system (GPS) receiver mounted on the vehicle 10 and calculates a distance between the position of the vehicle 10 and the predetermined vehicle stop location, thereby determining whether or not the vehicle 10 is located within the predetermined distance from the predetermined vehicle stop location. Also, a transmitter is disposed on the predetermined vehicle stop location and a receiver is mounted on the vehicle 10. A signal which is transmitted from the transmitter disposed on the predetermined vehicle stop location and is received by the receiver of the vehicle 10 is inputted to the vehicle control system 100. The vehicle control system 100 calculates a distance between the position of the vehicle 10 and the predetermined vehicle stop location, thereby determining whether or not the vehicle 10 is located within the predetermined distance from the predetermined vehicle stop location. Also, the predetermined distance may be 20 m. When the threat detection condition is set that the vehicle 10 is located within the predetermined position from the predetermined vehicle stop location, it is possible to detect the threat at about the time when the passengers get out of the vehicle 10. Likewise, by using the position and speed of the threat detected from a time point before a point of time when the passengers get out of the vehicle, it is possible to more reliably determine whether a below-described threat exists in a predetermined area or not.

When the threat detection condition is met, the vehicle control system 100 starts to detect the threat (S400). Specifically, for example, in a case where the threat detection condition is set that the speed of the vehicle 10 is less than 20 km/h, when the speed of the vehicle 10 is reduced below 20 km/h, the vehicle control system 100 starts to detect the threat to the first area 810 of the side of the vehicle 10, which has been recorded by the first video sensor 510, and the second area 820 of the rear of the vehicle 10, which has been recorded by the second video sensor 520. When the threat detection condition is not met, in other words, when the speed of the vehicle 10 exceeds 20 km/h, the vehicle control system 100 stops detecting the threat (S1400).

After starting to detect the threat, the vehicle control system 100 determines whether the door switch 210 of the vehicle 10 is turned on or not (S500). That is, the vehicle control system 100 determines whether or not the driver turns on the door switch 210 so as to open the door 700 of the vehicle 10.

When the door switch 210 of the vehicle 10 is in the on-state, the vehicle control system 100 determines whether or not the threat exists in the side or rear of the vehicle 10 (S700).

It may be a case where the driver stops the vehicle 10 to allow the passengers to get out of the vehicle and the driver turns on the door switch 210 so as to open the door 700 of the vehicle 10. Accordingly, the vehicle control system 100 may determine whether or not the threat exists in the side or rear of the vehicle 10. Specifically, the vehicle control system 100 may determine whether or not the threat exists in the side or rear of the vehicle 10 on the basis of the first video signal recorded by the first video sensor 510 and/or the second video signal recorded by the second video sensor 520. The vehicle control system 100 may detect the position and speed of the threat on the basis of the right side image of the vehicle, which has been by recorded by the first video sensor 510, and/or the rear image of the vehicle, which has been recorded by the second video sensor 520, and may determine whether or not there is a possibility that the threat becomes a threat to the passengers getting out of the vehicle.

Also, as shown in FIG. 4, the vehicle control system 100 may determine whether or not the threat exists in a B zone, i.e., an area within 2 meters from the door of the vehicle 10. Here, the vehicle control system 100 may synthesize the position and moving speed of the detected threat and may determine whether the threat exists in the B zone or not. Specifically, even though the detected threat exists at a position very close to the B zone, for example, a position apart from the B zone by 1 meter, when it is determined that the threat is in a stationary state, the threat is not expected to enter the B zone while the passenger are getting out of the vehicle. Therefore, the vehicle control system 100 may determine that the threat does not exist in the B zone. Even though the detected threat exists at a position apart from the B zone by a certain distance, for example, by 10 meters, when it is determined that the threat is moving toward the B zone at a high speed, there is a possibility that the threat enters the B zone while the passenger are getting out of the vehicle. Therefore, the vehicle control system 100 may determine that the threat exists in the B zone. More specifically, the vehicle control system 100 may determine whether or not the threat exists in the B zone of the side of the vehicle on the basis of the first video signal recorded by the first video sensor 510 and the second video signal recorded by the second video sensor 520. The vehicle control system 100 may detect the position and speed of the threat on the basis of the right side image of the vehicle, which has been recorded by the first video sensor 510, and may determine whether or not there is a possibility that the threat enters the B zone, and thus, determine whether or not the threat exists in the B zone. Also, the vehicle control system 100 may detect the position and speed of the threat on the basis of the rear image of the vehicle, which has been recorded by the second video sensor 520, and may determine whether or not there is a possibility that the threat enters the B zone, and thus, determine whether or not the threat exists in the B zone. Also, the vehicle control system 100 may synthesize the right side image of the vehicle, which has been recorded by the first video sensor 510 and the rear image of the vehicle, which has been recorded by the second video sensor 520, detect the position and speed of the threat, determine whether or not there is a possibility that the threat enters the B zone, and thus, determine whether or not the threat exists in the B zone.

As such, since there may occur an accident in which the passengers getting out of the vehicle 10 collide with the threat near the vehicle stop location, the vehicle control system 100 is able to determine whether or not the threat exists in the side or rear of the vehicle in a relatively wide range.

In a case where the threat exists in the side or rear of the vehicle 10, when the door 700 of the vehicle is opened and the passengers get out of the vehicle, there is a possibility of the occurrence of the accident. Therefore, the vehicle control system 100 prevents the door 700 of the vehicle 10 from being opened, operates the warning light or buzzer which is disposed within the vehicle 10, and displays a warning signal on the monitor (S800), so that the threat can be notified to the driver or passengers. Then, the vehicle control system 100 returns again to the step S500 of determining whether the door switch 210 of the vehicle 10 is turned on or not. If the driver releases the turning on the door switch 210, the passengers are not expected to get out of the vehicle. Accordingly, the vehicle control system 100 stops operating the warning light or buzzer and stops displaying the warning signal on the monitor (S600), and then returns to the step (S300) of determining whether the threat detection condition is satisfied or not.

In a case where the threat does not exist in the side or rear of the vehicle 10, the vehicle control system 100 opens the door 700 of the vehicle 10, stops operating the warning light or buzzer, and stops displaying the warning signal on the monitor (S900). Specifically, in a case where the door switch 210 of the vehicle 10 is in the on-state, when the threat which existed in the side or rear of the vehicle 10 disappears, the passengers are able to safely get out of the vehicle. Therefore, the vehicle control system 100 opens the door 700 of the vehicle and releases all the operated warning means.

After the door 700 of the vehicle 10 is opened, the vehicle control system 100 determines whether the door switch 210 is turned off or not (S1000). That is, the vehicle control system 100 determines whether the driver has turned off the door switch 210 or not so as to close the door 700 of the vehicle 10.

When the door switch 210 of the vehicle 10 is in the off-state, the vehicle control system 100 determines whether or not the threat exists in the rear of the vehicle 10 (S1100).

After the door 700 of the vehicle 19 is opened, the passengers finish getting out of the vehicle. Here, since it may be a case where the driver turns off the door switch 210 in order to close the door 700 of the vehicle 10 and to start to move the vehicle 10 again. The vehicle control system 100 may determine whether the threat exists in the side of the vehicle 10 or not. Specifically, the vehicle control system 100 may determine whether the threat exists in the side of the vehicle 10 or not on the basis of the first video signal recorded by the first video sensor 510 and/or the second video signal recorded by the second video sensor 520. The vehicle control system 100 may detect the position of the threat on the basis of the right side image of the vehicle, which has been recorded by the first video sensor 510, and may determine whether or not the threat exists in the side of the vehicle by determining whether or not the threat has a possibility of being affected by the vehicle which starts to move.

Also, as shown in FIG. 4, the vehicle control system 100 may detect the threat in an A zone, i.e., an area within 1 meter from the door of the vehicle 10. Specifically, the vehicle control system 100 detects the position of the threat on the basis of the first video signal which is the right side image of the vehicle, which has been recorded by the first video sensor 510, thereby determining whether the threat exists in the A zone or not.

The vehicle 10 may be accelerated with the door 700 thereof opened or the clothes or belongings, etc., of the passenger who has got out of the vehicle 10 may be caught in the door 700. Therefore, the vehicle control system 100 prevents the acceleration of the vehicle 10 and detects the threat in the side of the vehicle in a relatively narrow range. Here, the threat may be a passenger who is getting in the vehicle or a passenger who has got out of the vehicle.

In a case where the threat exists in the side of the vehicle 10, when the door 700 of the vehicle 10 is closed, there is a possibility of the occurrence of the accident in which the passenger or the passenger's belonging is caught in the door 700 of the vehicle 10. Therefore, the vehicle control system 100 prevents the door 700 of the vehicle 10 from being closed, operates the warning light or buzzer which is disposed within the vehicle 10, and displays a warning signal on the monitor, so that the threat can be notified to the driver or passengers. Also, when the vehicle 10 starts to move with the door 700 of the vehicle 10 unclosed, a passenger who is getting in the vehicle or has got out of the vehicle in the side of the vehicle 10, or a passenger who has got in the vehicle 10 may be in danger. Therefore, the vehicle control system 100 prevents the acceleration of the vehicle 10 (S1200). Then, the vehicle control system 100 returns again to the step S1000 of determining whether the door switch 210 of the vehicle 10 is turned off or not. If the driver releases the turning off the door switch 210, the door 700 of the vehicle 10 is not expected to close and continues to open, so that the passengers are able to additionally get out of the vehicle 10. Therefore, the vehicle control system 100 returns to the step S700 of determining whether or not the threat exists in the side of the vehicle 10.

When the threat does not exist in the side of the vehicle 10, the vehicle control system 100 closes the door 700 of the vehicle 10, stops operating the warning light or buzzer, stops displaying the warning signal on the monitor, and releases the prevention of the acceleration of the vehicle 10 (S1300). Specifically, in a case where the door switch 210 of the vehicle 10 is in the off-state, when the threat which existed in the side of the vehicle 10 disappears, the vehicle 10 is able to safely start to move. Therefore, the vehicle control system 100 closes the door 700 of the vehicle 10 and releases all the operated warning means.

The vehicle control system 100 determines whether the starting power is turned off or not (S100). If the starting power is turned off, the operation of the vehicle control system 100 is terminated.

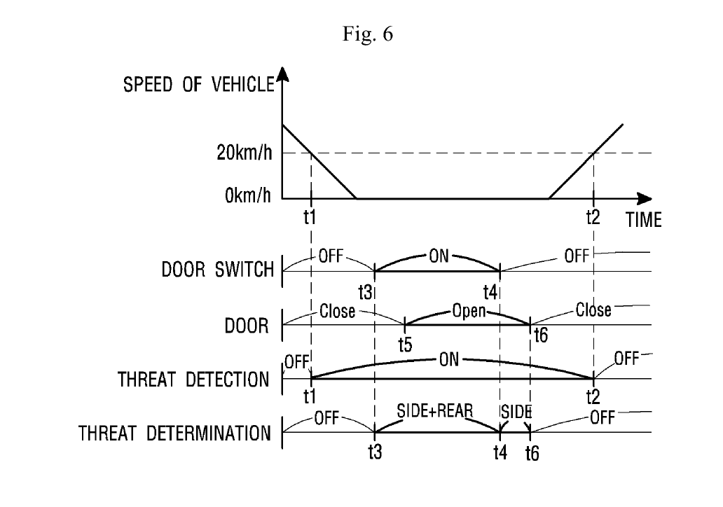

FIG. 6 is a graph showing time-based operations of the vehicle control method shown in FIG. 5.

First, when the vehicle 10 decreases its speed below 20 km (t1) in order to allow the passengers to get out of the vehicle, the vehicle control system 100 starts to detect the threat. Then, the vehicle 10 stops and the driver turns on the door switch 210 (t3), the vehicle control system 100 determines whether the threat exists in the side or rear of the vehicle or not. Here, the vehicle control system 100 may also determine whether the threat exists in the B zone or not. When the threat which existed disappears, the door 700 of the vehicle 10 is opened (t5). Here, if the threat does not exist in the side or rear of the vehicle, a point of time when the driver turns on the door switch 210 (t3) might be the same as a point of time when the door 700 of the vehicle 10 is opened (t5). Subsequently, the passengers finish getting out of the vehicle 10 and the driver turns off the door switch 210 (t4). Then, the vehicle control system 100 determines whether the threat exists in the side of the vehicle or not. Here, the vehicle control system 100 may also determine whether the threat exists in the A zone or not. When the threat which existed disappears, the door 700 of the vehicle 10 is closed (t6). Here, if the threat does not exist in the side of the vehicle, a point of time when the driver turns off the door switch 210 (t4) might be the same as a point of time when the door 700 of the vehicle 10 is closed (t6). Subsequently, when the vehicle 10 is accelerated and exceeds 20 km/h (t2), the vehicle control system 100 stops detecting the threat.

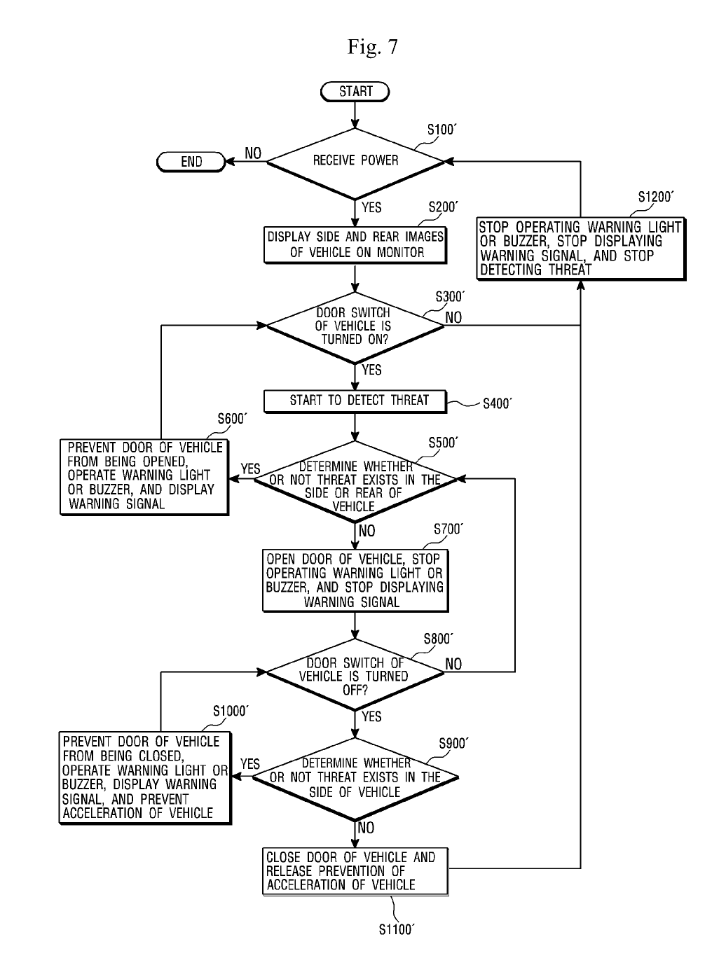

FIG. 7 is a flowchart for describing a vehicle control method of a vehicle control system according to another embodiment of the present invention.

Hereafter, in the description of the vehicle control method shown in FIG. 7, the same parts as those of the vehicle control method shown in FIG. 5 will be omitted. The following description will focus on differences between FIG. 7 and FIG. 5.

The threat detection condition of the vehicle control method shown in FIG. 7 may be that the door switch 210 of the vehicle 10 is in the on-state or the door 700 of the vehicle 10 is opened. Therefore, the vehicle control method does not include a separate step of determining whether the threat detection condition is satisfied or not and determines whether or not to start to detect the threat by determining whether the door switch 210 of the vehicle 10 is turned on or not. On-state of the door switch 210 of the vehicle 10 means, that the driver turns on the door switch 210 to allow the passengers to get out of the vehicle so that the passengers are expected to get out of the vehicle. Opening of the door 700 of the vehicle 10 means that, the passengers are getting out of the vehicle. In a case where the threat detection condition is set as that the door switch 210 is in the on-state or the door 700 of the vehicle 10 is opened, when the vehicle 10 stops according to signal waiting or traffic conditions rather than for the purpose of passengers' getting out of the vehicle, the vehicle control system 100 does not detect the threat. Only when the passengers get out of the vehicle, the vehicle control system 100 detects the threat.

In this case, the vehicle control system 100 determines whether or not the door switch 210 of the vehicle 10 is turned on (S300′). When the door switch 210 of the vehicle 10 is in the on-state, the vehicle control system 100 starts to detect the threat (S400′). Then, the operation until the door 700 of the vehicle 10 is closed is the same as that shown in FIG. 5. When the door switch 210 of the vehicle is not in the on-state, or when the door 700 of the vehicle 10 is closed due to no existence of the threat in the side of the vehicle 10 in a state where the door switch 210 of the vehicle 10 is in the off-state, the vehicle control system 100 releases all the operated warning means and stops detecting the threat (S1200′).

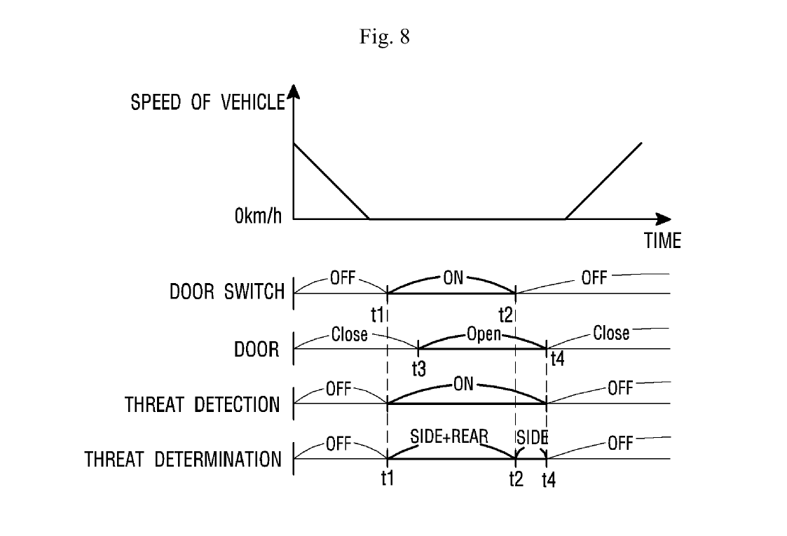

FIG. 8 is a graph showing time-based operations of the vehicle control method shown in FIG. 7.

First, when the vehicle 10 stops to allow the passengers to get out of the vehicle and driver turns on the door switch 210 (t1), the vehicle control system 100 starts to detect the threat and determines whether or not the threat exists in the side or rear of the vehicle. Here, the vehicle control system 100 may also determine whether the threat exists in the B zone or not. When the threat which existed disappears, the door 700 of the vehicle 10 is opened (t3). Here, if the threat does not exist in the side or rear of the vehicle, a point of time when the driver turns on the door switch 210 (t1) might be the same as a point of time when the door 700 of the vehicle 10 is opened (t3). Subsequently, the passengers finish getting out of the vehicle 10 and the driver turns off the door switch 210 (t2). Then, the vehicle control system 100 determines whether the threat exists in the side of the vehicle or not. Here, the vehicle control system 100 may also determine whether the threat exists in the A zone or not. When the threat which existed disappears, the door 700 of the vehicle 10 is closed and the vehicle control system 100 stops detecting the threat (t4). Here, if it had not been for the threat in the side of the vehicle, a point of time when the driver turns off the door switch 210 (t2) might be the same as a point of time when the door 700 of the vehicle 10 is closed (t4).

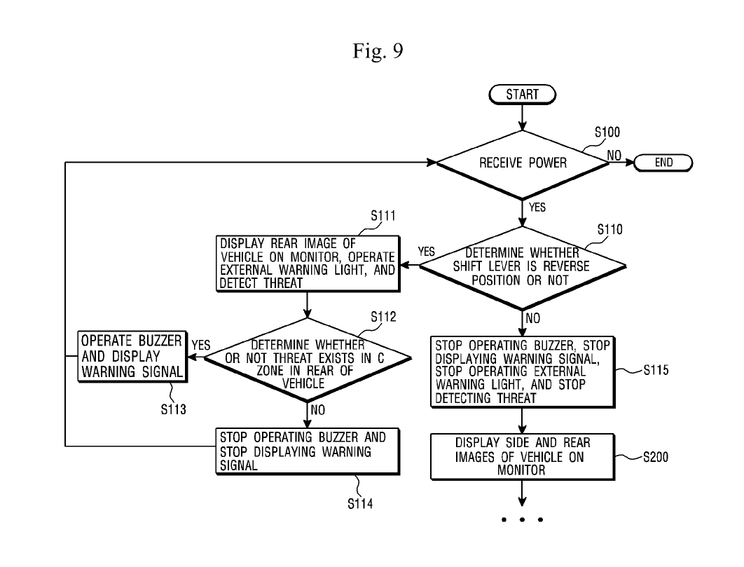

FIG. 9 is a flowchart for describing the vehicle control method of the vehicle control system which further includes a control function depending on a shift lever state in accordance with the embodiment of the present invention.

The vehicle control system 100 may further include a control function depending on the shift lever state. As shown in FIG. 9, after the vehicle control system 100 receives electric power and starts to operate (S100), the vehicle control system 100 determines whether the shift lever is a reverse position or not (S110).

When the shift lever is a reverse position, it may be a case where the vehicle 10 reverses. The vehicle control system 100 displays the rear image of the vehicle 10 on the monitor, operates an external warning light, and starts to detect the threat in the second area 820 of the rear of the vehicle 10 (S111). In this case, the rear image of the vehicle 10 is displayed on the entire monitor. Parking lines are displayed together and help the driver reverse the vehicle. The threat can be notified to the outside of the vehicle 10 by operating the external warning light.

Subsequently, as shown in FIG. 4, the vehicle control system 100 determines whether or not the threat exists in a C zone, i.e., an area within 2 meters from the rear of the vehicle 10 (S112). Since there may occur an accident in which the vehicle 10 reverses and collides with the threat in the rear of the vehicle, the vehicle control system 100 determines whether or not the threat exists in the C zone in a relatively wide range.

When the threat exists in the C zone of the rear of the vehicle 10, the vehicle control system 100 may notify the driver of the threat by displaying the warning signal on the monitor and by operating the buzzer disposed within the vehicle 10 (S113).

When the threat does not exist in the C zone of the rear of the vehicle 10, the vehicle control system 100 stops operating the buzzer and stops displaying the warning signal on the monitor (S114). Specifically, in a case where the shift lever of the vehicle is in the reverse position, when the threat which existed in the C zone of the rear of the vehicle 10 disappears, the vehicle 10 is able to safely reverse. The vehicle control system 100 stops operating the buzzer and stops displaying the warning signal.

When the shift lever is not in the reverse position, the vehicle control system 100 stops operating the buzzer, stops displaying the warning signal, stops operating the external warning light, and stops detecting the threat (S115). Specifically, in a case where the shift lever of the vehicle is not in the reverse position, the vehicle 10 is not expected to reverse. Therefore, the vehicle control system 100 stops the external warning light and all the operated warning means, and stops detecting the threat in the rear of the vehicle 10.

The vehicle control system 100 displays the side image and rear image of the vehicle 10 on the monitor (S200), and then the subsequent operation is the same as that of the vehicle control method shown in FIG. 5 or 7.

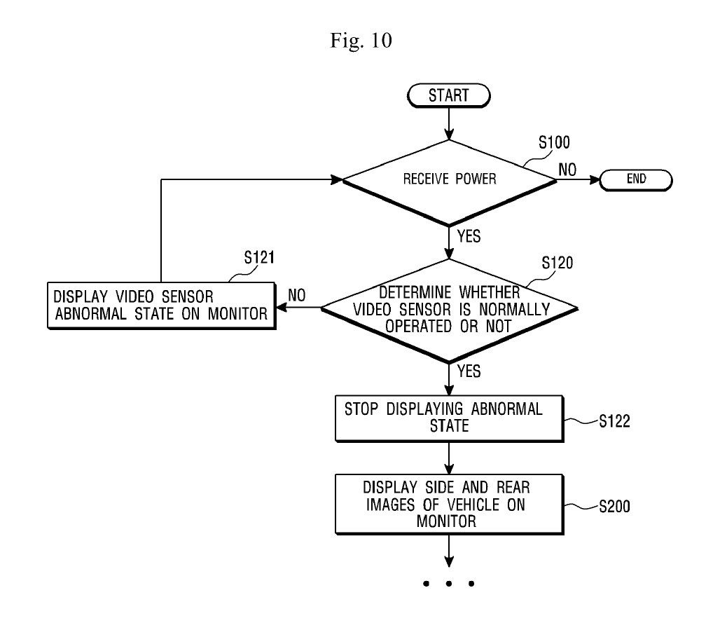

FIG. 10 is a flowchart for describing the vehicle control method of the vehicle control system which further includes a control function depending on a video sensor operation state in accordance with the embodiment of the present invention.

The vehicle control system 100 may further include a control function depending on the video sensor operation state. As shown in FIG. 10, after the vehicle control system 100 receives electric power and starts to operate (S100), the vehicle control system 100 determines whether the video sensor is normally operated or not (S120). Specifically, a method determining whether the video sensor is normally operated or not is performed as follows. The vehicle control system 100 receives video sensor state information from the first video sensor 510 and the second video sensor 520. Then, if the video sensor state is maintained abnormally for greater than 1 second, the vehicle control system 100 may determine the video sensor does not operate normally.

When at least any one of the first video sensor 510 and the second video sensor 520 does not operate normally, the vehicle control system 100 according to the embodiment of the present invention does not detect the threat or determines that the threat exists even though the threat does not exist, so that the vehicle 10 may not be operated as desired. Therefore, the vehicle control system 100 displays the video sensor abnormal state on the monitor (S121) and the vehicle control system 100 shown in FIG. 5 or 7 is prevented from being operated. In this case, the door 700 can be opened and closed by the operation of the door switch 210 by the driver, and the vehicle 10 can be accelerated by the operation of the acceleration pedal. The warning light or buzzer disposed within the vehicle 10 is not operated.

When both of the first video sensor and the second video sensor are normally operated, the vehicle control system 100 displays the side image and rear image of the vehicle 10 on the monitor (S200), and then the subsequent operation is the same as that of the vehicle control method shown in FIG. 5 or 7.

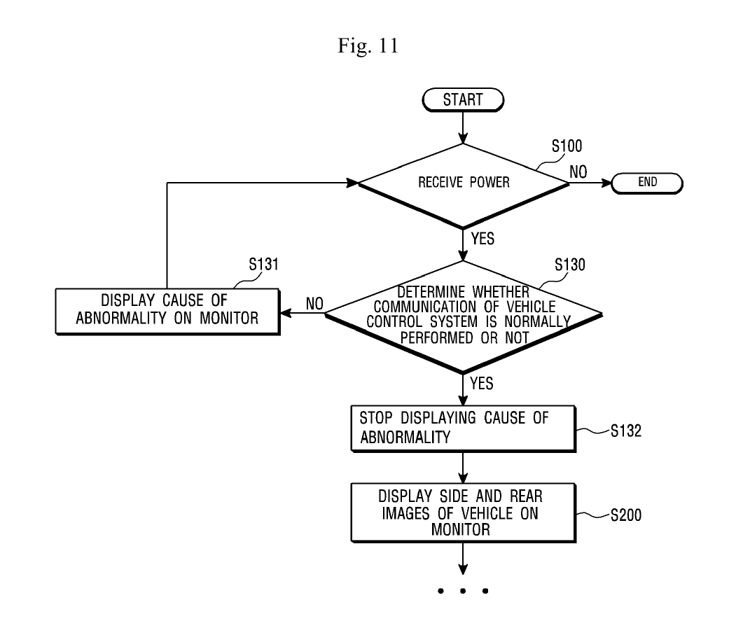

FIG. 11 is a flowchart for describing the vehicle control method of the vehicle control system which further includes a control function depending on a communication state in accordance with the embodiment of the present invention.

The vehicle control system 100 may further include a control function depending on the communication state of the vehicle control system 100. As shown in FIG. 11, after the vehicle control system 100 receives electric power and starts to operate (S100), the vehicle control system 100 determines whether the communication of the vehicle control system 100 is normally performed or not (S130). Specifically, a method determining whether the communication of the vehicle control system 100 is normally performed or not is performed as follows. Information on whether the threat exists in the side or rear of the vehicle 10 or not is transmitted from the video analysis unit 120 to the vehicle control unit 110 in a UART communication manner. When the information is not received for greater than 1 second, it may be determined that the communication of the vehicle control system 100 is not normally performed.

When the communication of the vehicle control system 100 is not normally performed, the vehicle control system 100 according to the embodiment of the present invention may not normally determine whether or not the threat exists and the vehicle 10 may not be operated as desired. Therefore, the vehicle control system 100 displays a cause of the abnormality on the monitor (S131) and the vehicle control system 100 shown in FIG. 5 or 7 is prevented from being operated. In this case, the door 700 can be opened and closed by the operation of the door switch 210 by the driver, and the vehicle 10 can be accelerated by the operation of the acceleration pedal. The warning light or buzzer disposed within the vehicle 10 is not operated.

When the communication of the vehicle control system 100 is normally performed, the vehicle control system 100 displays the side image and rear image of the vehicle 10 on the monitor (S200), and then the subsequent operation is the same as that of the vehicle control method shown in FIG. 5 or 7.

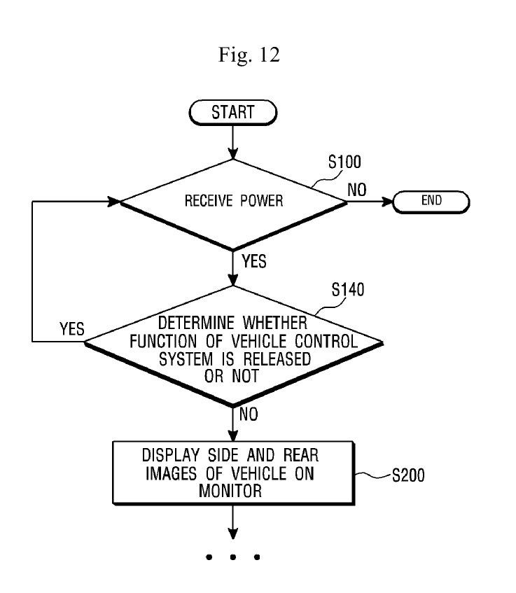

FIG. 12 is a flowchart for describing the vehicle control method of the vehicle control system which further includes a release function in accordance with the embodiment of the present invention.

The vehicle control system 100 may further include a release function. As shown in FIG. 12, after the vehicle control system 100 receives electric power and starts to operate (S100), the vehicle control system 100 determines whether the function thereof is released or not (S140). Specifically, a switch for enabling or disabling the function of the vehicle control system 100 is disposed adjacent to the driver's seat within the vehicle 10. If necessary, the driver may operate the vehicle 10 by enabling or disabling the vehicle control system 100.

When the function of the vehicle control system 10 is released, the vehicle control system 100 shown in FIG. 5 or 7 is prevented from being operated. In this case, the door 700 can be opened and closed by the operation of the door switch 210 by the driver, and the vehicle 10 can be accelerated by the operation of the acceleration pedal. The warning light or buzzer disposed within the vehicle 10 is not operated.

When the function of the vehicle control system 10 is not released, the vehicle control system 100 displays the side image and rear image of the vehicle 10 on the monitor (S200), and then the subsequent operation is the same as that of the vehicle control method shown in FIG. 5 or 7.

The features, structures and effects and the like described in the embodiments are included in one embodiment of the present invention and are not necessarily limited to one embodiment. Furthermore, the features, structures, effects and the like provided in each embodiment can be combined or modified in other embodiments by those skilled in the art to which the embodiments belong. Therefore, contents related to the combination and modification should be construed to be included in the scope of the present invention.

Although embodiments of the present invention were described above, these are just examples and do not limit the present invention. Further, the present invention may be changed and modified in various ways, without departing from the essential features of the present invention, by those skilled in the art. For example, the components described in detail in the embodiments of the present invention may be modified. Further, differences due to the modification and application should be construed as being included in the scope and spirit of the present invention, which is described in the accompanying claims.

What is claimed is:

1. A vehicle control unit which protects passengers of a vehicle comprising a door switch, a speed sensor, an acceleration pedal rotation angle sensor, a door control unit, an engine control unit, and at least one of a warning light and a buzzer,
wherein the vehicle control unit receives a door opening closing operation signal from the door switch, receives a speed of the vehicle from the speed sensor, and receives an acceleration pedal rotation angle from the acceleration pedal rotation angle sensor,
wherein, when a threat detection condition is met, the vehicle control unit receives information on whether a threat exists or not in the side or rear of the vehicle,
wherein, when the threat does not exist in the side or rear of the vehicle, the vehicle control unit outputs the door opening closing operation signal to the door control unit and outputs the acceleration pedal rotation angle to the engine control unit, and
wherein, when the threat exists in the side or rear of the vehicle, the vehicle control unit does not output the door opening closing operation signal to the door control unit or outputs the door opening closing operation signal controlled to prevent the door from being opened to the door control unit, and outputs an on-signal to the warning light or the buzzer disposed within the vehicle.

2. The vehicle control unit of claim 1, wherein the threat detection condition is that the speed is less than a predetermined speed.

3. The vehicle control unit of claim 1, wherein the threat detection condition is that the vehicle is located within a predetermined distance from a predetermined vehicle stop location.

4. The vehicle control unit of claim 1, wherein the threat detection condition is that the door opening closing operation signal is in an on-state.

5. The vehicle control unit of claim 1, wherein, when the threat exists in the side of the vehicle in a state where the door of the vehicle is opened, the vehicle control unit outputs a controlled acceleration pedal rotation angle to the engine control unit.

6. A vehicle control system which protects passengers of a vehicle comprising a door switch, a speed sensor, an acceleration pedal rotation angle sensor, a door control unit, an engine control unit, and at least one of a warning light and a buzzer, the vehicle control system comprising:
a video analysis unit; and
a vehicle control unit,
wherein, the vehicle control unit receives a door opening closing operation signal from the door switch, receives a speed of the vehicle from the speed sensor, receives an acceleration pedal rotation angle from the acceleration pedal rotation angle sensor, and receives information on whether or not a threat exists in the side or rear of the vehicle from the video analysis unit,
wherein, when the threat does not exist in the side or rear of the vehicle, the vehicle control unit outputs the door opening closing operation signal to the door control unit and outputs the acceleration pedal rotation angle to the engine control unit,
wherein, when the threat exists in the side or rear of the vehicle, the vehicle control unit does not output the door opening closing operation signal to the door control unit or outputs the door opening closing operation signal controlled to prevent the door from being opened to the door control unit, and outputs an on-signal to the warning light or the buzzer disposed within the vehicle,
wherein the video analysis unit receives a first video signal from a first video sensor which records the side of the vehicle or a second video signal from a second video sensor which records the rear of the vehicle, and
wherein, when a threat detection condition is met, the video analysis unit determines whether or not the threat exists in the side or rear of the vehicle on the basis of the first video signal or the second video signal, and outputs the information on whether or not the threat exists in the side or rear of the vehicle to the vehicle control unit.

7. The vehicle control system of claim 6, wherein the threat detection condition is that the speed is less than a predetermined speed.

8. The vehicle control system of claim 6, wherein the threat detection condition is that the vehicle located within a predetermined distance from a predetermined vehicle stop location.

9. The vehicle control system of claim 6, wherein the threat detection condition is that the door opening closing operation signal is in an on-state.

10. The vehicle control system of claim 6, wherein, when the threat exists in the side of the vehicle in a state where the door of the vehicle is opened, the vehicle control unit outputs a controlled acceleration pedal rotation angle to the engine control unit.

11. The vehicle control system of claim 6, wherein, when the threat exists in the side or rear of the vehicle, the video analysis unit outputs the first video signal comprising a warning signal or the second video signal comprising a warning signal to a monitor disposed within the vehicle.

12. A vehicle comprising a vehicle control system for protecting passengers, the vehicle comprising:
the vehicle control system comprising a video analysis unit and a vehicle control unit;
a first video sensor which records the side of the vehicle and outputs a recorded first video signal to the vehicle control system;
a second video sensor which records the rear of the vehicle and outputs a recorded second video signal to the vehicle control system;
a door switch which is disposed within the vehicle and outputs a door opening closing operation signal to the vehicle control system;
an acceleration pedal rotation angle sensor which outputs an acceleration pedal rotation angle of the vehicle to the vehicle control system;
a speed sensor which outputs a speed of the vehicle to the vehicle control system;
a door control unit which drives a door of the vehicle;
an engine control unit which drives an engine of the vehicle; and
at least one of a warning light and a buzzer which is disposed within the vehicle,
wherein the vehicle control unit receives information on whether or not a threat exists in the side or rear of the vehicle from the video analysis unit,
wherein, when the threat does not exist in the side or rear of the vehicle, the vehicle control unit outputs the door opening closing operation signal to the door control unit and outputs the acceleration pedal rotation angle to the engine control unit,
wherein, when the threat exists in the side or rear of the vehicle, the vehicle control unit does not output the door opening closing operation signal to the door control unit or outputs the door opening closing operation signal controlled to prevent the door from being opened to the door control unit, and outputs an on-signal to the warning light or the buzzer, and
wherein, when a threat detection condition is met, the video analysis unit determines whether or not the threat exists in the side or rear of the vehicle on the basis of the first video signal or the second video signal, and outputs the information on whether or not the threat exists in the side or rear of the vehicle to the vehicle control unit.

13. The vehicle of claim 12, wherein the threat detection condition is that the speed is less than a predetermined speed.

14. The vehicle of claim 12, wherein the threat detection condition is that the vehicle located within a predetermined distance from a predetermined vehicle stop location.

15. The vehicle of claim 12, wherein the threat detection condition is that the door opening closing operation signal is in an on-state.

16. The vehicle of claim 12, wherein, when the threat exists in the side of the vehicle in a state where the door is opened, the vehicle control unit outputs a controlled acceleration pedal rotation angle to the engine control unit.

17. The vehicle of claim 14, further comprising:
a monitor which is disposed within the vehicle; and
a shift lever state sensor which outputs a shift lever state of the vehicle to the vehicle control system,
wherein the vehicle control unit outputs information on the shift lever state to the video analysis unit, and
wherein, when the shift lever state is a reverse position, the video analysis unit outputs the second video signal to the monitor, and when the input shift lever state is not the reverse position, the video analysis unit outputs the first video signal and the second video signal to the monitor.

18. The vehicle of claim 14, further comprising a monitor which is disposed within the vehicle, wherein, when the threat exists in the side or rear of the vehicle, the video analysis unit outputs the first video signal comprising a warning signal or the second video signal comprising a warning signal to the monitor.
